(19) United States
(12) Patent Application Publication
(10) Pub. No.: US 2026/0145650 A1
(43) Pub. Date: May 28, 2026

(54) CAR WASH CONVEYER SYSTEM FOR OVERSIZED VEHICLES

(71) Applicant: ZZ Tech, LLC, Spring, TX (US)

(72) Inventor: Zavian Rolando Valdez, Apollo Beach, FL (US)

(21) Appl. No.: 19/403,675

(22) Filed: Nov. 28, 2025

Related U.S. Application Data
(60) Provisional application No. 63/725,871, filed on Nov. 27, 2024.

(51) Int. Cl. B60S 3/00; B65G 17/24

(52) U.S. Cl. CPC B60S 3/004; B65G 17/24; B65G 2811/093

(57) ABSTRACT

A car wash conveyor system for oversized vehicles comprising a support frame extending the length of the conveyor, a plurality of support blocks connected to the frame, and a plurality of cylindrical rollers coupled to the support blocks and positioned at intervals along the length of the conveyor. The conveyor also includes a drive drum and idler drum connected to opposite ends of support frame. A belt is in contact with the drive drum and the idler drum. The belt rotates over the drive drum and the idler drum as the drive drum is driven by a drive motor. Each roller only substantially rotates in response to a vehicle load pressing the belt against the roller.

### CROSS-REFERENCE TO RELATED APPLICATIONS

The present application claims priority under 35 U.S.C. § 119(e) to U.S. Provisional Patent Application No. 63/725,871, filed Nov. 27, 2024, entitled “Car Wash Conveyor System for Oversized Vehicles”. The above-identified provisional patent application is hereby incorporated by reference in its entirety for all purposes.

### TECHNICAL FIELD

The present disclosure relates in general to the field of car washes, and more particularly to a novel heavy duty car wash conveyor system capable of handling oversized vehicles weighing substantially more than passenger cars and trucks, as well at a method of use.

### BACKGROUND

Some conventional car washes employ an over-and-under chain conveyor system designed to move vehicles through a car wash tunnel by using a metal chain that loops around two sprockets at opposing ends of the conveyor system. The system typically consists of steel components—chains, sprockets, angle irons, and rollers—that work in tandem to carry a vehicle through various stages of the washing process. Over-and-under chain conveyor systems have several limitations that affect performance and lifespan, such as susceptibility to rust and corrosion in the harsh car wash environment.

Other conventional car wash conveyor systems employ a plastic conveyor belt comprised of multiple hinged components engaged with one another. These multiple hinged components permits the overall plastic conveyor belt to be flexible or bendable so that it can be wrapped around a drive drum at one end to move the conveyor belt, and an idle drum on the opposite end. These multiple hinged components provide numerous slots where a toothed drive drum, typically also comprised of plastic, engages and pulls the plastic conveyor belt. Plastic conveyor belts also have several limitations that affect performance and lifespan, such as vehicle weight capacity and susceptibility to erosion and extreme temperatures in the harsh car wash environment. Furthermore, plastic conveyor belts are not strong enough to move oversized vehicles, such as a bus, semi-tractor trailer, dump truck and other large and heavy vehicles.

Accordingly, what is needed in the art is a conveyor system without a plastic design, and which is strong enough to support and pull heavy, oversized vehicles easily. The disclosed heavy duty conveyor system provides such advantages over conventional approaches.

### SUMMARY

Novel aspects of the present disclosure are directed to a car wash conveyor system, comprising a support frame extending the length of the conveyor, a plurality of support blocks connected to the frame, and a plurality of cylindrical rollers positioned at intervals along the length of the conveyor. Each support block comprises at least one aperture configured to rotatably receive a cylindrical roller. The conveyor system also includes a drive drum connected to the support frame at a first end of the conveyor and an idler drum connected to the frame at a second end of the conveyor opposite the drive drum. The drive drum is connected to a drive motor and is configured to rotate the drive drum. The conveyor also includes a belt in contact with the drive drum and the idler drum, wherein the belt rotates over the drive drum and the idler drum as the drive drum is driven by the drive motor. Each roller only substantially rotates in response to a vehicle load pressing the belt against the roller.

In another embodiment, novel aspects of the disclosed principles are directed to a method for conveying an oversized vehicle using a novel car wash conveyor system. The method comprises the steps of driving the belt along the length of the conveyor; maintaining the belt in a raised position above the rollers such that the rollers remain substantially stationary when no external load is applied to the belt; receiving an external load on a localized portion of the belt; deflecting the localized portion of the belt downward to bring the localized portion of the belt in contact with underlying rollers; rotating the contacted rollers in response to movement of the belt; and sequentially engaging and disengaging rollers as the external load moves along the length of the conveyor.

Other aspects, embodiments, and features of the disclosed principles will become apparent from the following detailed description when considered together with the accompanying figures. In the figures, each identical or substantially similar component that is illustrated in various figures is represented by a single numeral or notation. For the purposes of clarity, not every component is labeled in every figure. Nor is every component of each embodiment of the disclosed principles shown where illustration is not necessary to allow those of ordinary skill in the art to understand the principles disclosed herein.

### BRIEF DESCRIPTION OF THE DRAWINGS

The novel features believed to be characteristic of the disclosure are set forth in the appended claims. The disclosure itself, however, as well as a preferred mode of use, further objectives, and advantages thereof, will be best understood by reference to the following detailed description of illustrative embodiments when read in conjunction with the accompanying drawings, in which:

FIG. 1 illustrates a partial cross-sectional side view of one embodiment of a heavy-duty car wash conveyor system designed and constructed in accordance with the disclosed principles;

FIG. 1A illustrates a closeup view of the inset shown in FIG. 1;

FIGS. 2A-2B illustrate perspective views of exemplary embodiments of rollers for use in a conveyor system in accordance with the disclosed principles;

FIGS. 3A-3D illustrate perspective views of exemplary embodiments of support blocks for use in a conveyor system in accordance with the disclosed principles;

FIGS. 4A-4C illustrate perspective views of a support frame of a conveyor system in accordance with the disclosed principles;

FIG. 5 illustrates a perspective closeup view of an exemplary embodiment of support blocks coupled to a support frame and corresponding roller of an exemplary conveyor system;

FIGS. 6A-6B illustrate perspective views of exemplary embodiments of roller assemblies with debris sleeves in a conveyor system in accordance with the disclosed principles;

FIG. 7A illustrates a front view of an exemplary embodiment of a drum for use in a conveyor system in accordance with the disclosed principles;

FIG. 7B illustrates perspective views of one end of a conveyor system as disclosed herein employ the drum of FIG. 7A;

FIG. 8 illustrates a perspective view of an exemplary embodiment of a drive motor of a conveyor system in accordance with the disclosed principles;

FIG. 9 illustrates a perspective view of an exemplary embodiment of a belt of a conveyor system as disclosed herein;

FIG. 10 illustrates a perspective view of an exemplary embodiment of a belt with vehicle movement stops of a conveyor system as disclosed herein;

FIG. 11 illustrates a front perspective view of an exemplary embodiment of a conveyor system as disclosed herein in operation;

FIG. 12 illustrates a rear perspective view of an exemplary embodiment of a conveyor system as disclosed herein in operation; and FIG. 13 illustrates a flow diagram setting forth an exemplary method of moving an oversized vehicle using a conveyor system in accordance with the disclosed principles.

### DETAILED DESCRIPTION

Conventional car wash conveyor systems are prone to significant wear and tear in the harsh car wash environment. Additionally, conventional car wash conveyor systems are not configured to withstand the additional weight associated with moving oversized vehicles such as buses, semi-tractor trailers, delivery vehicles, dump trucks and other large and heavy vehicles. Novel aspects of this disclosure recognize the need for a durable conveyor system that can move oversized vehicles. The heavy-duty conveyor system as disclosed features a controlled rotation mechanism that allows for consistent movement and minimizes wear on the belt and rollers, thereby decreasing maintenance needs, reducing downtime and costs, and improving overall productivity. The conveyor design is adaptable to various applications and environments, making it suitable for a variety of industries outside of traditional car washes.

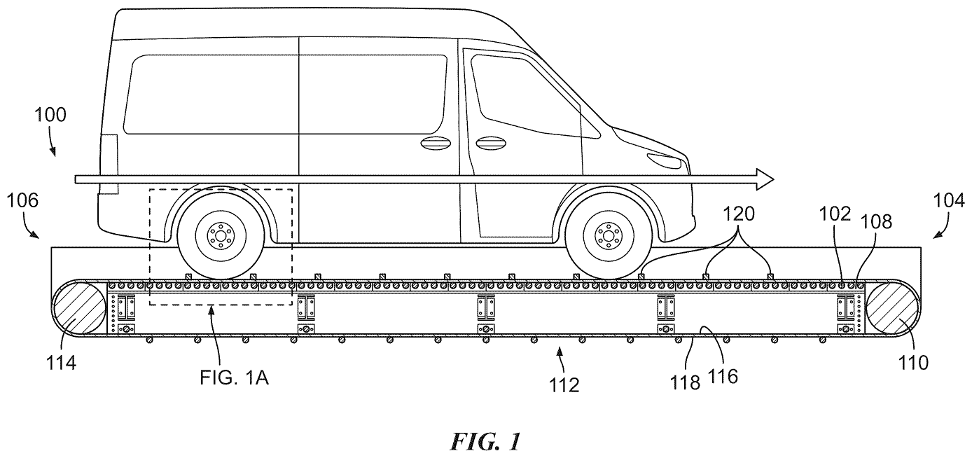

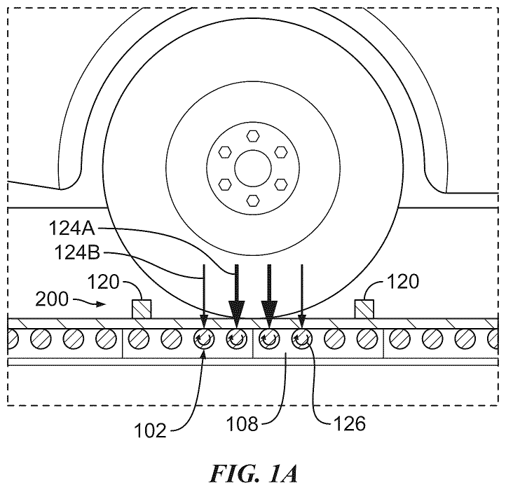

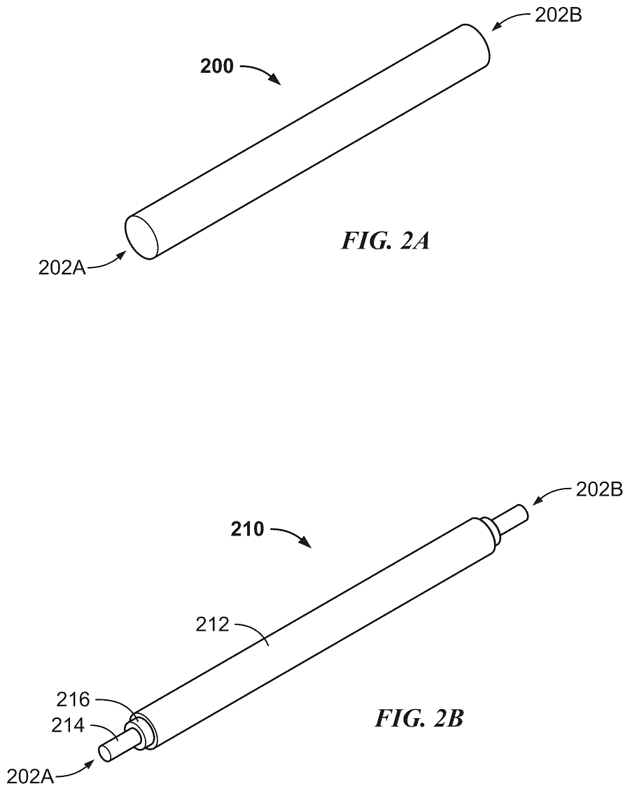

Referring to FIG. 1, illustrated is a partial cross-sectional side view of one embodiment of a conveyor 100 designed and constructed in accordance with the disclosed principles. In the non-limiting exemplary embodiment illustrated in FIG. 1, conveyor 100 may include a plurality of cylindrical rollers 102. Rollers 102 may be positioned horizontally and parallel with one another in close proximity and at intervals along the length of the conveyor 100 between a first end 104 and a second end 106 of conveyor 100. In exemplary embodiments, when referring to conveyor 100 as disclosed herein, the first end 104 may also be referred to as the front end 104 of conveyor 100, and second end 106 of conveyor 100 may also be referred to as rear end 106 of conveyor 100. Rollers 102 may be constructed from durable material to support the extreme weights of oversized vehicles. As a non-limiting example, rollers 102 may be constructed from metal, such as carbon steel or stainless steel or a combination thereof. Rollers 102 are discussed in greater detail with reference to FIGS. 2A-2B.

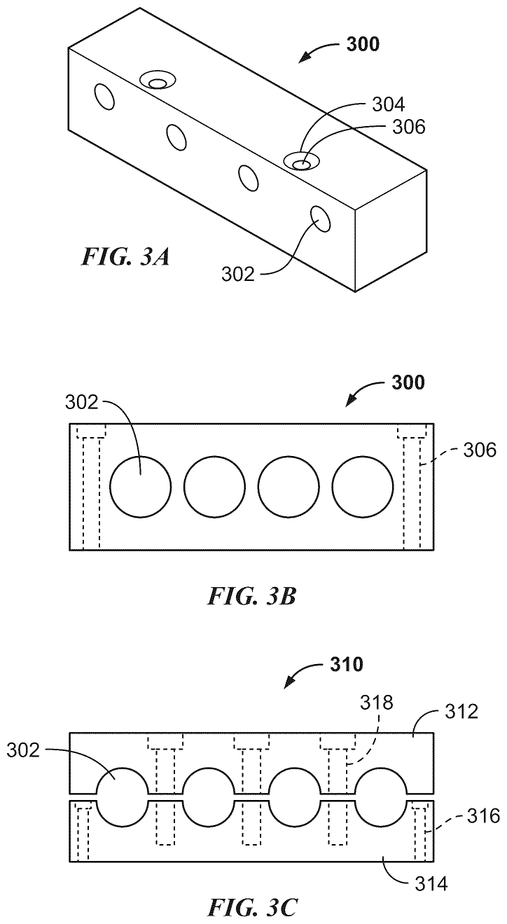

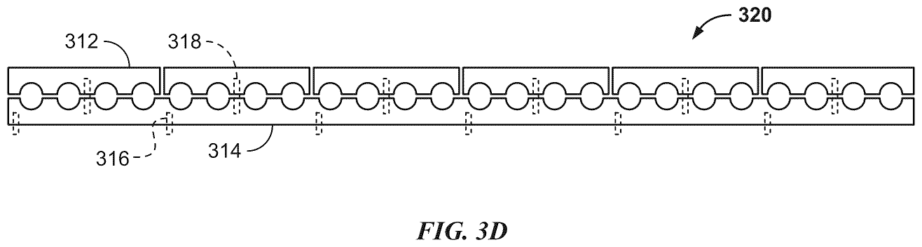

The plurality of rollers 102 may be rotationally coupled to support blocks 108 to form a roller deck assembly. In an embodiment, rollers 102 may be coupled to support blocks 108 via cylindrical apertures (not shown) formed in the support blocks 108, discussed in greater detail with reference to FIG. 3A-3D. Support blocks 108 may be formed from self-lubricating material to reduce friction and wear on the moving parts, thereby ensuring that support blocks 108 require less maintenance and perform well under the wet and abrasive conditions typically found in a car wash environment. The use of self-lubricating materials also eliminates the need for bearings on the rollers 102 or routine lubrication, further reducing construction costs, maintenance needs and improving performance in the carwash environment. Non-limiting examples of self-lubricating materials include polyethylene, nylon, Teflon®, Delrin®, ultra-high-molecular-weight polyethylene (UHMW), and the like. In an exemplary embodiment, the support blocks 108 comprises a polyethylene (PE) material characterized by several distinct properties, making it particularly suitable for high-wear applications. The PE material may exhibit a strong correlation with UHMW. In an embodiment, the PE material may further demonstrate a crystallinity level of approximately 81.72%, which imparts superior mechanical strength and durability, allowing the support blocks 108 to withstand continuous mechanical stress over prolonged use. Additionally, the melting point of the PE material, as determined by differential scanning calorimetry, may be approximately 130.52° C., imparting thermal stability in elevated-temperature environments. These specific properties, coupled with the PE material's natural resistance to moisture, render the support blocks 108 particularly well-suited for use in environments such as vehicle wash roller assemblies, where exposure to abrasive conditions, humidity, and varying temperatures is prevalent. In other embodiments, support blocks 108 may be formed from metals, such as steel, oil-impregnated brass, or bronze, to improve strength of the support blocks 108. In these embodiments, self-lubricating materials may be disposed at the interface between the rollers 102 and the support blocks 108, thereby providing improved strength without losing the material interaction provided by the self-lubricating material.

Support blocks 108 may extend the length of the conveyor 100. In the non-limiting exemplary embodiment illustrated in FIG. 1, the length of each support block 108 may be less than the length of the conveyor 100 and a plurality of support blocks 108 may be used to support the rollers 102. As a non-limiting embodiment, each support block 108 may be approximately 12 inches in length. Of course, other lengths for each of the support blocks 108 may also be used. In other embodiments, each support block 108 may extend the length of the conveyor 100 such that only two support blocks 108 are required. Each support block 108 may support a predetermined number of rollers 102.

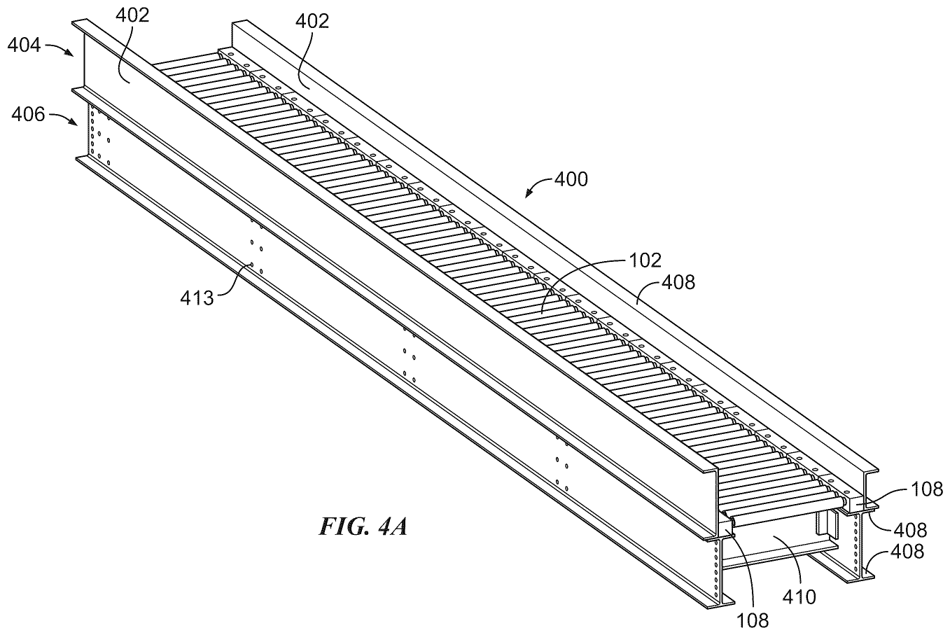

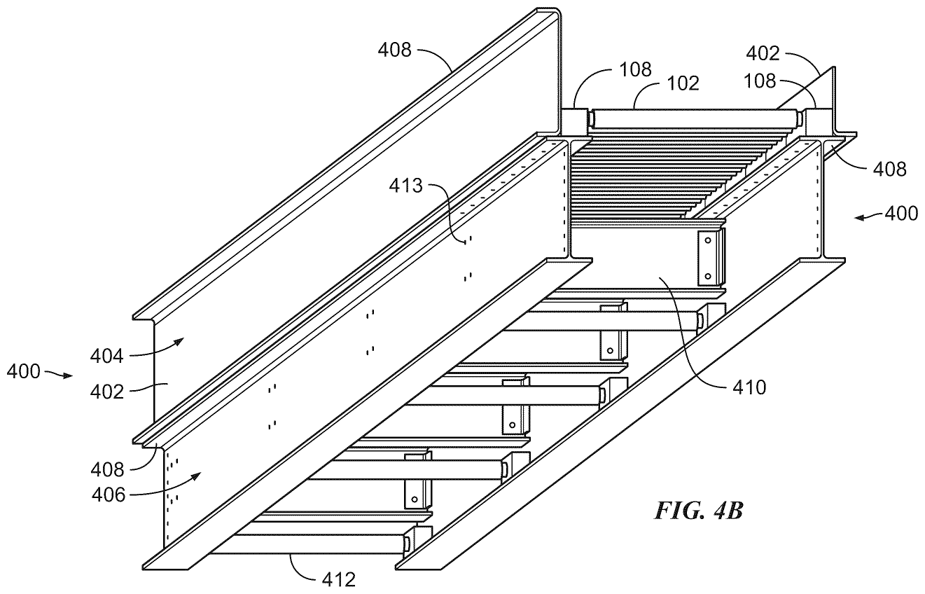

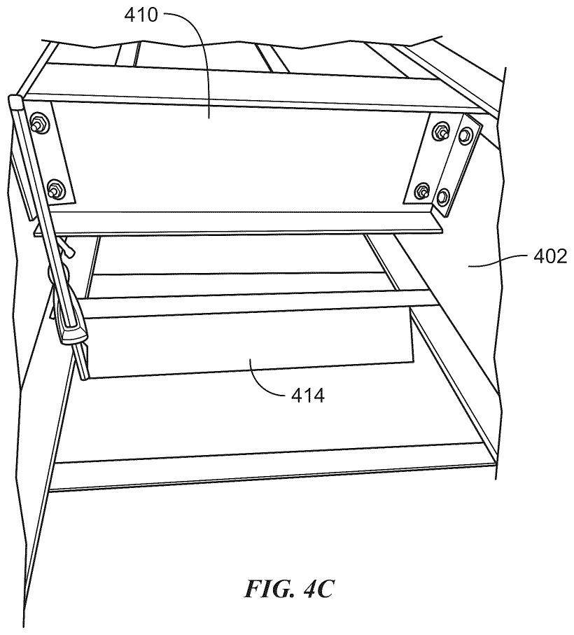

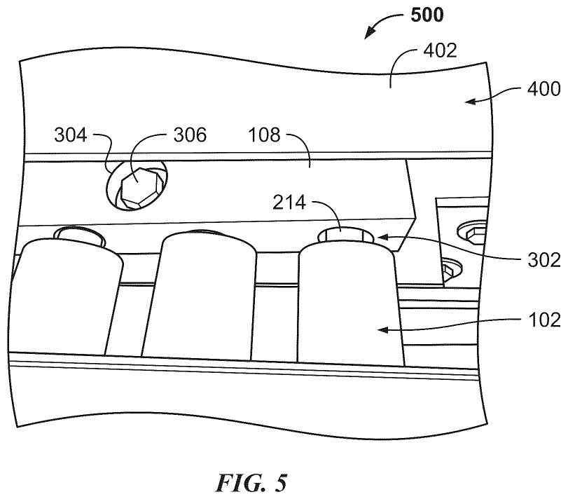

In the non-limiting exemplary embodiment illustrated in FIG. 1, each support block 108 may support four rollers 102. Support blocks 108 may be coupled to a support frame (shown under the ends of the support blocks 108), which itself may be comprised of single lengths of material or multiple lengths couple end-to-end. In an embodiment, support blocks 108 may be secured to the support frame via fasteners (not shown) such that damaged or worn support blocks 108 may easily be removed and replaced. For example, if the cylindrical aperture of a support block 108 is worn too big overtime from rotation of a roller 102 therein, the support block 108 may be removed and replaced with a new support block 108 with a cylindrical aperture sized to securely receive the roller 102. Support blocks 108 are discussed in greater detail with reference to FIGS. 3A-3D. Support frame is discussed in greater detail with reference to FIGS. 4A-4C. Fasteners are discussed in greater detail with reference to FIG. 5.

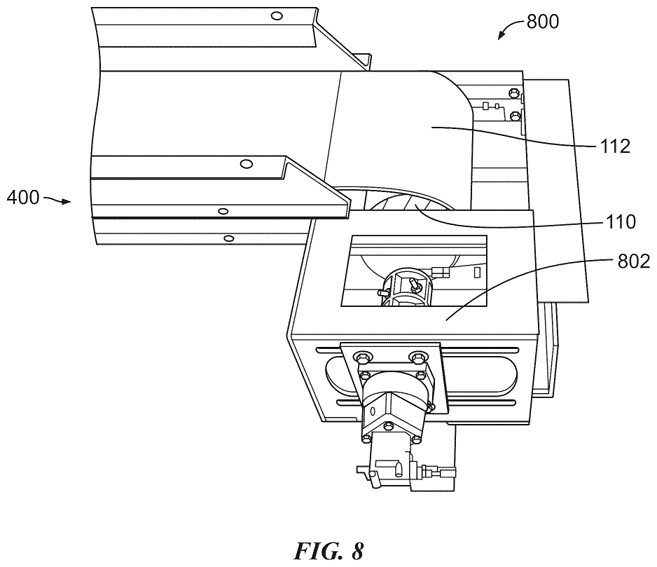

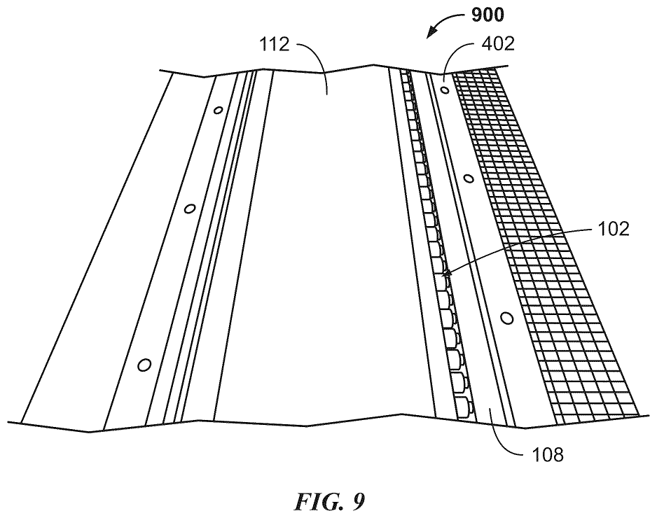

Conveyor 100 may also include a drive drum 110 configured to impart motion on the belt 112, discussed in greater detail below. Drive drum 110 may be positioned at one or both of the first end 104 and second end 106 of conveyor 100. In the non-limiting exemplary embodiment illustrated in FIG. 1, drive drum 110 may be positioned at the front end 104 of conveyor 100. This approach differs from the industry-standard practice of utilizing a drive drum at the point of entrance and presents several advantages. By employing drive drum 110 as the steering actuator at the point of exit, the conveyor system 100 achieves enhanced directional control over the belt 112, discussed in greater detail below. The high precision in steering becomes critically important for vehicles having front-end alignment anomalies, a condition frequently observed in commercial vans and heavy-duty trucks that have been subjected to extensive wear and tear. Through this steering mechanism, such vehicles are maintained in correct alignment as they traverse down the length of the conveyor 100. Drive drum 110 may be coupled to a drive motor (not shown) configured to rotate the drive drum 110 about an axis of rotation. Drive motor is discussed in greater detail with reference to FIG. 8.

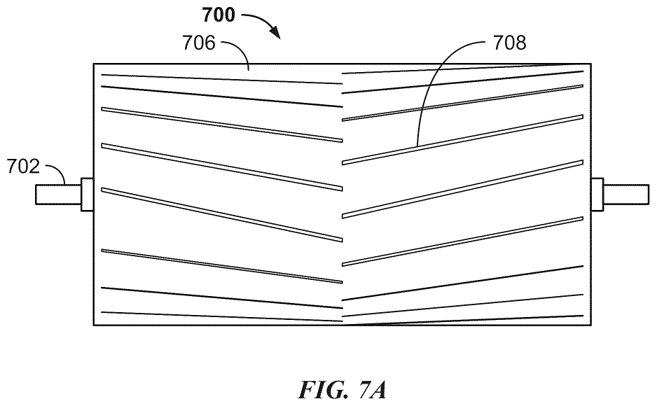

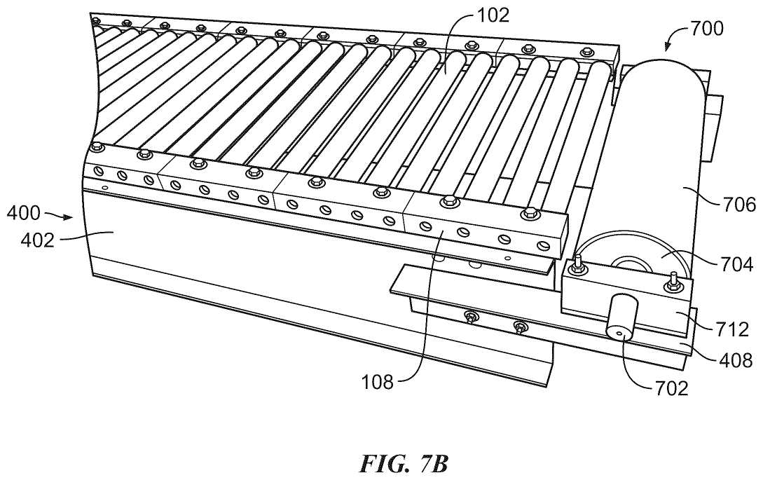

Conveyor 100 may also include an idler drum 114 to support and maintain tension in belt 112. In the non-limiting exemplary embodiment illustrated in FIG. 1, idler drum 114 may be positioned at the second or rear end 106 of conveyor 100. The drive drum 110 and idler drum 114 may be the same diameter as each other, or different diameters. In some embodiments, drive drum 110 is larger in diameter than an idler drum 114. For example, idler drum 114 may be 8 inches in diameter, while drive drum 110 may be 12 inches in diameter. Drive drum 110 and idler drum 114 (collectively “drums 110, 114”) are discussed in greater detail with reference to FIG. 7A-7B.

In some embodiments, the conveyor may comprise additional large intermediate rollers (not shown) spaced between idler drum 114 positioned at the entrance of the conveyor 100 and drive drum 110. These intermediate rollers spaced throughout the middle of the conveyor 100 prevent the belt 112 from sagging too much onto the rollers 102 by creating a portion where the belt 112 is reelevated above rollers 102 in the middle portions of the conveyor 100. In some embodiments, each of the intermediate rollers may be spaced equidistant from each other between the drive drum 110 and the idler drum 114.

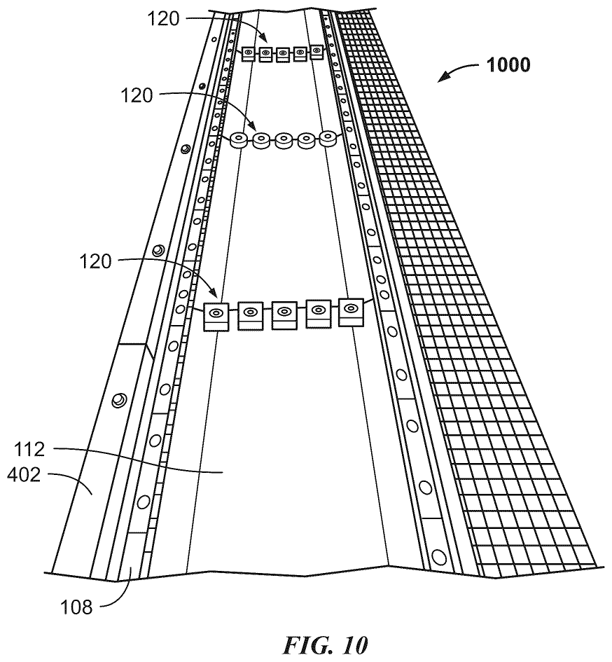

Conveyor 100 includes a belt 112 disposed around the drums 110, 114 and rollers 102 such that belt 112 sits atop the rollers 102. Belt 112 may include an inner surface 116 contacting the rollers 102 and drums 110, 114 and an outer surface 118 configured to contact the tires of a vehicle. As the drive motor rotates the drive drum 110, the drive drum 110 may impart motion to the belt 112 and the belt 112 may impart motion to a vehicle positioned on the belt 112. Belt 112 is discussed in greater detail with reference to FIG. 9. In the non-limiting exemplary embodiment illustrated in FIG. 1, the outer surface of the belt 118 may include vehicle movement stops 120 to help to push vehicles along the length of conveyor 100. Vehicle movement stops 120 are discussed in greater detail with reference to FIG. 10.

In an embodiment, conveyor 100 is designed such that only some of the rollers 102 are engaged as a vehicle traverses the length of the conveyor 100, thereby enhancing durability of the system by reducing unnecessary wear and tear. For example, the conveyor 100 may be configured such that each roller 102 only turns when it is supporting a sufficient weight, such as the weight of a vehicle wheel, thereby greatly reducing the number of rotations of each roller 102 and preserving the rollers 102 and support blocks 108. As such, when there is no weight directly above a roller 102, belt 112 may slide above or over the surface of the roller 102 without causing the roller 102 to rotate. As a vehicle's tire deforms under load, the contact point—the area of the tire that makes contact with the conveyor 100—typically extends over a section of the conveyor 100 that includes multiple rollers 102, depending on the size of the tire, the load it carries, the diameters of the rollers 102, and the spacing of the rollers 102. This spanning distributes the load across multiple rollers 102, thereby reducing the stress on any single roller 102 and enhancing the overall durability of the conveyor system 100.

Looking now at FIG. 1A, illustrated is a closeup view of the inset portion illustrated in FIG. 1. FIG. 1A illustrates the same partial cross-sectional side view of the inset portion of the conveyor 100, which includes the rollers 102, support blocks 108, belt 112, and stops 120. As shown in FIG. 1A, as a vehicle tire presses the bely 112 downwardly as it is pulled longitudinally by the conveyor 100, the load of the tire is not typically uniformly distributed across all engaged rollers 102 due to factors such as the tire's shape, deformation, and the specific load distribution on the axle. Instead, the load might be more heavily concentrated on the rollers 102 directly under the tire's central contact point, illustrated by large arrows 124A, with progressively less load on the rollers 102 towards the edges of the contact point, illustrated by small arrows 124B. Only when the tires presses downwardly on the belt 112 and thus the rollers 102 under the tire, the contacted rollers 102 rotate, illustrated by arced arrows 126, as the belt 112 is moved to pull the tire

Specifically, as a non-limiting example, drive drum 110 may be sized such that the belt 112 is suspended above the plurality of rollers 102 and does not contact the rollers 102 unless a sufficient downward force is applied to the belt 112. For example, the highest point of drive drum 110 and idler drum 114 may be elevated relative to the highest point of any of rollers 102. As a non-limiting example, the highest point of the drive drum 110 and idler drum 114 may be 0.5 inches higher than the highest point of any of rollers 102. In another embodiment, the highest point of drive drum 110 and idler drum 114 may be the same height as the highest point of any of rollers 102. In these embodiments, belt 112 is in constant contact with rollers 102. However, the principle that rollers 102 only turn when a vehicle's tire is present on top of said rollers 102 remains true. This is because, due to the weight of rollers 102, the friction between belt 112 and rollers 102 is not, in and of itself, enough to cause rollers 102 to rotate without additional force in such embodiments.

In an embodiment, rollers 102 may not complete a full rotation even when sufficient weight is applied to turn the roller 102. As a non-limiting example, each roller 102 may only rotate ½ to ¾ of a turn as the vehicle is moved along the conveyor 100. The amount of rotation that a roller 102 undergoes is primarily determined by the length of the tire's contact point—the area of the tire that is in contact with belt 112 at any given time, as well as by the selected diameter of the rollers 102. For example, a longer contact point might occur in larger or heavily loaded vehicles and results in more of the tire's surface passing over the roller 102, leading to a greater amount of rotation.

Also, the smaller the selected diameter of each roller 102 is, the more each roller 102 is rotated when contacted by the moving belt 112. Also, as the diameter of the rollers 102 is increased, not only is the spacing between the rollers 102 increased so as to maintain desired spacing between them, but the mounting point of the shaft ends of the rollers 102 (discussed further below) is lowered such that the desired spacing between the tops of the rollers 102 and the belt 112 when not pressed downwardly by a tire is maintained. Stated another way, the diameter of the rollers 102 does not need to be a constant, but instead may be selected, within reason, so long as close spacing between rollers 102 is maintained, as well as between the underside of the belt 112 and the rollers 102. Moreover, the diameter of the rollers 102 may be selected so that the desired number of rollers 102 are simultaneously contacted by the belt 112 as it pressed downwardly by a vehicle tire. In the illustrated embodiment, the diameter of the rollers 102, as well as their spacing, is selected such that four rollers 102 are contacted simultaneously. As such, smaller diameter rollers 102, where the same spacings are maintained, may be employed so that more rollers 102 are contacted simultaneously, and the converse is true as well.

In some embodiments, it may be desirable to minimize the circumferential friction force from the belt such that the incidental friction of the belt 112 and roller 102 interaction is insufficient to overcome the inertia of the roller 102 and the static friction of the support blocks 108 on the shaft ends of each roller 102 (i.e., a breakaway torque for the resting support block 108). In some embodiments, friction between the belt 112 and the rollers 102 may be minimized by selecting particular materials for the components. For example, the inner surface 116 of belt 112 may be formed from low-friction material. As another example, the outer surface of the rollers 102 may be polished to reduce friction. Additionally or alternatively, the inner surface 116 of the belt 112 and/or outer surface of the rollers 102 may be lubricated with water or oil to minimize the friction between the rollers 102 and the belt 112. In some embodiments, friction between the rollers 102 and belt 112 may be additionally or alternatively minimized by tensioning belt 112 between drive drum 110 and idler drum 114 such that the catenary formed by the sagging belt 112 applies a minimal normal force between belt 112 and each roller 102. Note that a vehicle and its respective load will apply additional tension by riding the belt 112. Similarly, by using a shorter distance between the drive drum 110 and idler drum 114, less catenary sag can be achieved to minimize the normal force. A lighter belt 112, such as a thinner belt or one with less dense polymer, can also reduce this force or the sag. A heavier belt 112 will sag and apply more normal force to the rollers 112 due to its own weight, which could cause the rollers 102 to turn even without a load. A lighter belt 112 will be less likely to cause the rollers 102 to rotate unless additional force from a transported object is present. The belt 112 should be lightweight but durable, with a balance between weight and strength.

Additionally, the weight of each roller 102 plays a role in whether the minimal force of a belt 112 without the weight of a tire causes the rollers 102 to rotate. For example, heavy rollers are less likely to be rotated by such minimal force, while lightweight rollers may be more easily rotated. Additionally, the fit between the shaft ends of each roller 102 and the holes in the support blocks 108 receiving the shaft ends plays a role in whether the minimal force of a belt 112 without the weight of a tire causes the rollers 102 to rotate. For example, a tight fit between the shaft ends and the holes of the support blocks 108 will resist rotation of the rollers 102, regardless of their weight, while a loose fit between the two will permit rotation of the rollers 102. As such, heavy rollers with a loose fit will have the tendency to rotate easily (and perhaps continuing to free-rotate in some situations once the static friction is overcome) due to rotational inertia as compared to lightweight rollers 102. Thus, the weight or mass of the rollers plays a more important role in supporting the weight of vehicles traversing the rollers 102 than in resisting rotation of the rollers 102.

In some embodiments, each roller 102 has a mass selected such that, under a tension and weight provided by the belt 112 without any additional load (such as the load provided by a vehicle), a torque exerted by the belt on the idler roller is less than a breakaway torque of the roller 102, thereby preventing rotation of the roller 102 when no load is present on the belt 112. In some embodiments, rollers 102 weigh approximately 18 pounds. The weight of rollers 102 can vary. For example, rollers 102 may weigh 10 to 25 pounds, depending on the specific application and materials used. However, these weights are merely illustrative, and the conveyor 100 as presently disclosed should not be limited to these specific weights. The weight of the roller 102 can change with the width and length requirements of the belt. For example, a higher belt 112 will require a heavier roller 102 to prevent rotation of the roller 102 due to frictional engagement by the belt 112. As an alternative example, a belt 112 with a width of 14 inches would require half the weight of the roller 102. In some embodiments, the load-bearing capacity of each roller 102 is at least to 3,000 pounds. Rollers 102 have been shown to support at least 14,000 pounds per foot (or across 4 idler rollers). Rollers 102 have also been shown to support 30,000 pounds for over an hour, with no damage to the bushing or change in its shape.

In an embodiment, conveyor 100 may form part of a comprehensive vehicle wash system. That is, conveyor 100 may carry a vehicle through a vehicle wash facility or car wash tunnel as various wash related activities are carried out. In some embodiments, the conveyor system 100 can be configured with various conveyor lengths to accommodate different facility sizes and operational needs. For instance, conveyor lengths may range from shorter options, such as 30 to 50 feet, to mid-range lengths of 70 to 100 feet, and even extend to longer configurations of 120 feet or more. These length options provide flexibility in designing wash systems tailored to the specific requirements of a facility and the length of the vehicles to be washed, whether they focus on high-volume quick washes or more thorough multi-stage processes. Shorter conveyors may be ideal for compact or express wash facilities, while longer conveyors allow for additional stages without the need to move vehicles between different sections manually. The conveyor system 100 is not limited to these specific lengths, and custom configurations beyond the disclosed ranges can be implemented.

Conveyor 100 may also be configured to accommodate a wide range of vehicle sizes, both in terms of vehicle weights and lengths. Specifically, the structure of the conveyor 100 considers factors such as vehicle height, width, wheel size, distance from the inside of the left wheel to the outermost part of the vehicle on the right side, wheelbase, and overhang behind the back tire.

Referring to FIGS. 2A and 2B, illustrated are exemplary embodiments of rollers designed and constructed in accordance with the disclosed principles. As previously discussed, conveyor 100 may include a plurality of cylindrical rollers rotatably coupled to support blocks (not shown). In the non-limiting exemplary embodiment illustrated in FIG. 2A, each roller 200 may be a uniform cylinder sized to slip-fit into the cylindrical apertures formed in the support blocks. Each roller 200 may include a first end 202a and a second end 202b (collectively, “roller ends 202”) sized to fit into cylindrical apertures formed in the support blocks.

Each roller end 202 may be coupled to a support block. That is, a first support block may support the first end 202a of roller 200 and a second support block may support the second end 202b of roller 200. In the non-limiting exemplary embodiment illustrated in FIG. 2B, each roller 210 may include an outer shell 212 and an inner shaft or rod 214. The outer shell 212 may be cylindrical shell with a central opening 216. The inner rod 214 may be configured to fit through the opening 216 of the outer shell 212. The inner rod 214 may be longer than the outer shell 212 such that the inner rod 214 extends beyond the outer shell 212 and forms the roller ends 202, which are in turn held within the apertures of the support blocks. As an example, outer shell 212 of roller 210 may comprise a total 2-inch diameter and a 1-inch central opening 216 containing rod 214. As another example, outer shell 212 of rollers 210 may be 24 inches long, while rod 214 may be 28 inches long, extending 2 inches outward from each side of the roller. As an alternative example, outer shell 212 of rollers 210 may be 14 inches long, while rod 214 may be 16 inches long, extending 2 inches outward from each side of the roller. These examples are merely illustrative, and the conveyor system disclosed herein should not be limited to these specific dimensions or configurations.

The inner rod 214 may serve as the strength of the rollers 210, as well as the axle about which the roller 210 rotates. The inner rod 214 may be formed from durable material such as steel. The outer shell 212 may be formed from aluminum or other lightweight metal. The combination of the hollow outer shell 212 and the inner rod 214 provides a reliable, low-friction, and durable component that is well-suited for the car wash environment. Moreover, the use of aluminum for the outer shell 212 can reduce the cost of each roller 210, as well as the weight of each roller 210 to provide the advantages discussed above. In some embodiments, the rollers 210 may comprise a carbon steel outer shell 212 with a central opening 216 that can accommodate a stainless-steel inner rod 214. The material choice of stainless steel in this example is predicated upon its intrinsic attributes of wear and attrition resistance, extending the assembly's operational lifespan. This dual-material construction may allow the roller deck to withstand a wide array of mechanical stresses and strains. In some embodiments, rod 214 may be removable from outer shell 212. In some embodiments, outer shell 212 and rod 214 are welded together, and rod 214 is secured with a set screw (not shown). This design allows for the easy removal and replacement of rod 214. In some embodiments, roller 210 is made entirely of stainless steel, with the ends machined down on both sides to accommodate the fit into support blocks. This construction ensures high resistance to corrosion and wear, making it ideal for harsh car wash environments. In some embodiments, stainless-steel rod 214 is inserted into an outer shell 212 comprised of ultra-high-molecular-weight (UHMW) polyethylene, plastic, nylon, urethane, polyurethane, Delrin (acetal), or Teflon (PTFE). These materials are known for their high durability, low friction, and excellent wear resistance, making these rollers particularly suitable for heavy-duty applications, where reducing friction and protecting the belt material are priorities.

Referring briefly back to FIG. 1A, in some embodiments, conveyor 100 can support and transport fully loaded 80,000-pound tractor-trailers in less than two minutes. The total load-bearing capacity of the conveyor 100 can be determined by the sum of the capacities of rollers 102 that are actively supporting the vehicle's tires at any given time. For example, if a vehicle's tires span across four rollers 102 on each side, and each roller 102 is rated at 3,000 pounds, the total capacity of these eight rollers 102 would be 24,000 pounds. Given that the maximum highway weight for a single axle is approximately 17,000 pounds-dividing to 8,500 pounds per side-the conveyor system 100 can accommodate any legally weighted vehicle. The conveyor 100 accounts for variability in load distribution, providing support while mitigating potential wear and tear on individual rollers 102.

Referring to FIGS. 3A-3D, illustrated is a perspective view of exemplary embodiments of support blocks designed and constructed in accordance with the disclosed principles. As previously discussed, rollers (not shown) may be coupled to support blocks 300 via cylindrical apertures 302 formed in the support blocks 300. Cylindrical apertures 302 may be sized and shaped to receive the roller ends (not shown) and allow rotation of the roller ends within the support block 300, with either a tight or loose fit.

In an embodiment, cylindrical apertures 302 may be formed only partially through the support block 300, thereby forming a closed end wall that functions as a backstop for the rollers 102. The resulting non-penetrating recess provides controlled insertion depth without compromising the structural integrity of the support block 300. Accordingly, the cylindrical apertures 302 may provide reliable axial support while maintaining a solid material layer behind it. In another embodiment, cylindrical apertures 302 may be formed fully through support block 300, forming a through-bore that opens at both ends. This configuration eliminates the end wall present in the blind-bore embodiment described above and allows for improved debris evacuation, thereby reducing friction and wear during rotation. The open geometry can also allow more precise alignment throughout the entire length of the cylindrical aperture 302, which in turn prevents lateral movement of the rollers during their rotation. Such embodiments prevent the ends of the outer shell of the rollers from butting up against the interior surface of the support blocks, as doing so can eat into the support blocks. Such wear eventually permits the rollers to move laterally during their rotation, which is undesirable.

In an embodiment, roller ends may be coupled to the cylindrical apertures 302 in a slip-fit manner. In some embodiments, grease fittings are incorporated into support blocks 300 to address minor squeaking issues or to simply provide lubrication, if desired. Cylindrical apertures 302 may be spaced along the length of each support block 300 in accordance with the width of the rollers such that a roller can be coupled to each cylindrical aperture 302 with sufficient space for rotation. For example, the cylindrical apertures 302 may be spaced such that the center of each roller may be separated by 3 inches, providing close and consistent support. In alternative embodiments, the spacing between cylindrical apertures 302, and thereby rollers, may be increased to accommodate different vehicle types or operational requirements, as well as different diameters of rollers. For instance, the cylindrical apertures 302 may be separated by greater or smaller intervals, such as 2 inches, 6 inches, 12 inches, 18 inches, or even 24 inches, depending on the desired balance between support and material use. The range of spacing allows conveyor 100 to be adapted for a variety of applications, from supporting lighter, more evenly distributed loads to handling heavier or less uniformly distributed loads. Support blocks 300 may also include apertures 304 configured to accept a fastener 306 to secure the support block 300 to the support frame (not shown). Fasteners are discussed in greater detail with reference to FIG. 5.

In the non-limiting exemplary embodiment illustrated in FIGS. 3A-3B, each support block 300 may be a unitary component with cylindrical apertures 302 configured to receive rollers (not shown). As previously discussed, support blocks 300 may be secured to the support frame (not shown) via fasteners 306 inserted through aperture 304. Any fastener that can achieve the purpose of securing the support block 300 is within the scope of the claims. As a non-limiting example, the fastener 306 may be a bolt.

In other embodiments, each support block may be formed from multiple components to permit easy disassembly and replacement of associated rollers. In the non-limiting exemplary embodiments illustrated in FIG. 3C and FIG. 3D, support blocks 310, 320 may comprise an upper portion 312 and a lower portion 314. The lower portion 314 may be secured to the support frame (not shown) via fasteners 316 inserted through apertures formed in the lower portion 314. The upper portion 312 may be secured to the lower portion 314 via fasteners 318 inserted through apertures formed in the upper portion 312 and lower portion 314. With fasteners 318 removed, only the upper portion 312 of the support block 310 can be removed such that the rollers coupled to the support block 310 can be readily removed. In the non-limiting exemplary embodiment illustrated in FIG. 3C, the upper portion 312 and lower portion 314 of support block 310 may be equally sized. In another embodiment, the lower portion 314 of support block 320 may be sized to support a greater number of rollers than the upper portion 312, as illustrated in FIG. 3D. In some embodiments, the lower portion 314 may extend the length of the conveyor 100.

Referring to FIGS. 4A-4C, illustrated are perspective views of a support frame 400 in accordance with the disclosed principles. Support frame 400 provides the structural foundation for each disclosed conveyor system, supporting the weight and forces exerted by the belt (not shown) and vehicles it transports.

In an embodiment, support frame 400 may include longitudinal support rails 402 extending the length of the conveyor 100. Support rails 402 can take any of several advantageous cross-sectional profiles, such as “H” or “I” beams, “C” channels, “L” angle iron, or other advantageous shape that can provide structural support along the length of the conveyor system. In the non-limiting exemplary embodiment illustrated in FIGS. 4A-4C, the support rails 402 include an upper channel 404 and a lower channel 406 with flanges 408 defining the edges of the channels 404, 406. Support blocks 108 may be positioned on the flanges 408 of each support rail 402 such that flanges 408 provide additional support for the support blocks 108 and associated rollers 102. In another embodiment, support blocks 108 may be attached to the support rails 402 within the channels 404, 406. Support rails 402 forming the upper channel 404 may also function as guide rails to help keep the tires of the vehicle on the conveyor 100 as the vehicle traverses the length of the conveyor 100. Guide rails may also serve to maintain the vehicular alignment and stability during transit across the conveyor 100.

In some embodiments, the support rails 402 are connected to each other at regular intervals by cross members 410. In some embodiments, support frame 400 further comprises modular attachment points 413 that allow for the incorporation of additional components. Attachment points 413 facilitate the quick and secure mounting of various system components, including but not limited to, support blocks 108, cross members 410 and bearings (not shown) for the drums (not shown). These components may be attached or detached without requiring permanent alterations to the surrounding infrastructure, making the system highly flexible and scalable. Attachment points 413 may be disposed along the flanges 408 and/or channels 404, 406 of the support rails 402.

In some embodiments, support frame 400 is comprised of structural steel or an equivalent material. Structural steel may be chosen for its balance of strength, durability, and cost-effectiveness, making it well-suited for heavy loads and stresses. However, alternative embodiments can utilize different materials for support frame 400. In some embodiments, support frame 400 is comprised of high-tensile steel, or an equivalent material. Using these materials, support frame 400 is capable of substantial load bearing and may be well-suited for a wide range of vehicles, including heavy-duty trucks and vans.

In other embodiments, support frame 400 may be constructed from angle steel or iron, which provide considerable strength and design flexibility. This material is utilized to construct a durable support frame 400 capable of supporting the significant weight and dynamic forces imparted by both the belt and the vehicles being transported. The design versatility of angle steel or iron allows for the customization of the conveyor system to accommodate an extensive range of vehicle sizes and weights.

In some embodiments, support frame 400 is rated for 50,000 pounds over a 5-foot length. Consequently, the conveyor can sustain the maximum weight of a fully loaded tractor-trailer, exceeding 80,000 pounds. The legal weight for a tractor-trailer is 34,000 pounds over a 10-foot length, well within the capacity of the conveyor system 100 when designed and constructed in accordance with the disclosed principles.

In some embodiments, return rollers 412 may also extend between the two support rails 402 on the underside of the conveyor 100 to support the belt (not shown) on its return path. Return rollers 412 help to maintain the alignment and tension in the belt. In the non-limiting exemplary embodiment illustrated in FIG. 4B, return rollers 412 may be spaced at greater intervals than rollers 102. Return rollers 412 may be secured to the support rails 402 or may have their own support blocks (not shown). As illustrated in FIG. 4C, conveyor 100 may additionally or alternatively include a plurality of plates 414 positioned at the bottom of support frame 400 to carry the belt as it passes underneath the conveyor 100.

Referring to FIG. 5, illustrated is a closeup perspective view 500 of support blocks 108 coupled to the support frame 400 and rollers 102. Support blocks 108 may be secured to support rails 402 via fasteners 306. In the non-limiting exemplary embodiment illustrated in FIG. 5, support blocks 108 may be removably coupled to the support rails 402 such that damaged or worn support blocks 108 may easily be removed and replaced. For example, if the cylindrical aperture 302 of a support block 108 is worn too big overtime from rotation of a roller 102 therein, the support block 108 may be removed and replaced with a new support block 108 with a cylindrical aperture 302 sized to securely receive the roller 102. As previously discussed, support block 108 may be removably secured to the support frame 400 via fasteners 306 inserted through apertures 304 formed in support blocks 108. Also as previously discussed, rollers 102 may be coupled to support blocks 108 via cylindrical apertures 302. In the non-limiting exemplary embodiment illustrated in FIG. 5, the inner rod 214 of roller 102 may be inserted into cylindrical aperture 302 to couple roller 102 to support block 108.

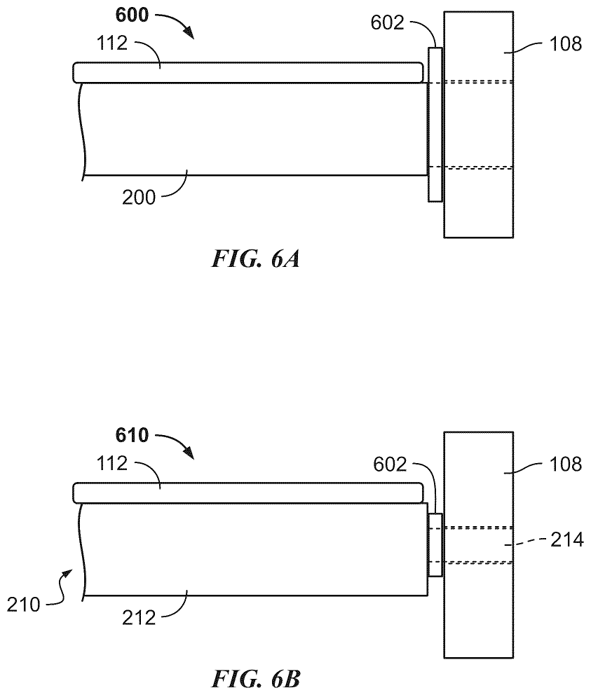

Referring to FIG. 6A and FIG. 6B, illustrated are exemplary roller assemblies 600, 610 with debris sleeves in accordance with the disclosed principles. In an embodiment, conveyor 100 may include debris sleeves 602 positioned around the rollers 200, 210 to prevent water and debris from entering the cylindrical apertures in the support blocks 108, thereby reducing or eliminating abrasive debris from entering the support blocks 108 and extending the life of support blocks 108 and rollers 200, 210. In the non-limiting exemplary embodiment illustrated in FIG. 6A, a roller 200 as illustrated in FIG. 2A is coupled to a support block 108. Debris sleeve 602 may be positioned around the circumference of the roller 200 and between the interior surface of the associated support block 108 and the edge of belt 112. In the non-limiting exemplary embodiment illustrated in FIG. 6B, a roller 210 as illustrated in FIG. 2B is coupled to a support block 108. Debris sleeve 602 may be mounted and secured onto the inner rod 214 of roller 210 and positioned between the outer shell 212 of the roller 210 and the interior surface of the support block 108.

Debris sleeves 602 may be constructed of any suitable material. Non-limiting exemplary materials include but are not limited to metal, plastic, or a self-lubricating material. Debris sleeves 602 may be coupled to the roller 200, 210 via a variety of methods. In an embodiment, a metal debris sleeve 602 may be welded to the roller 200, 210. In another embodiment, debris sleeve 602 may be removably coupled to the roller 200, 210. As a non-limiting example, debris sleeve 602 may be affixed to the roller 200, 210 with a fastener, such as a set screw, or press-fit onto the roller 200, 210. In an embodiment, the diameter of debris sleeve 602 may be greater than the diameter of the roller 200, 210 such that the debris sleeve 602 extends beyond the dimensions of the roller 200 to form a barrier between the belt 112 and the support block 108, as illustrated in FIG. 6A. In another embodiment, the diameter of debris sleeve 602 may be smaller than the diameter of roller 210, as illustrated in FIG. 6B. In yet another embodiment, the diameter of debris sleeve 602 may be equal to the diameter of roller 210.

Referring to FIGS. 7A-7B, illustrated are perspective views of a drum 700 in accordance with an illustrative embodiment. In the non-limiting exemplary embodiment illustrated in FIG. 7A, drum 700 may include a central shaft 702 defining an axis of rotation, a core (not shown) mounted concentrically about the shaft 702, and an exterior surface 706 disposed around the core and configured to engage the belt (not shown). Shaft 702 may extend beyond the core to engage bearings (not shown) coupled to the support frame (not shown), discussed in greater detail with reference to FIG. 7B. In some embodiments, shaft 702 may protrude from each end of the core. As an example, the core of drum 700 may be 26 inches long, while shaft 702 may be 28 inches long, extending 1 inch outward from each side of the drum 700. As an alternative example, the core of drum 700 may be 15 inches long, while shaft 702 may be 16 inches long, extending 0.5 inches outward from each side of the roller. These examples are merely illustrative, and the invention should not be limited to these specific dimensions or configurations. The shaft 702 and core may be formed from metal such as steel. The exterior surface 706 may be formed of a material selected to optimize frictional engagement, such as rubber, urethane, or a composite material to provide ample friction to grip the interior surface of the belt. In the non-limiting exemplary embodiment illustrated in FIG. 7A, grooves 708 may be formed in the exterior surface 706 to further assist with gripping the belt. Additionally or alternatively, the exterior surface 706 may be textured to increase the friction, and thus the grip, between the drum 700 and the belt. In some embodiments, the diameter of the core of drum 700 is wider at its longitudinal center point relative to the diameter of its cylindrical ends. With this configuration, the belt will naturally center itself on the drums 700 and rollers (not shown), even if it is deflected due to poor vehicle alignment, creating a self-tracking effect.

In the non-limiting exemplary embodiment illustrated in FIG. 7B, drum 700 may be coupled to the support frame 400 via bearings 712 secured to the support frame 400. That is, shaft 702 may be coupled to bearings 712 secured to the support frame 400. In some embodiments, bearings 712 are mounted to the flanges 408 of the support frame 400. As previously mentioned, drum 700 may include a central shaft 702 defining an axis of rotation, a core 704 mounted concentrically about the shaft 702, and an exterior surface 706 configured to engage the belt. In the case of a drive drum, shaft 702 may be coupled to the drive motor (not shown). In operation, rotation of the shaft 702 by the drive motor drives the core 704 and exterior surface 706 to impart motion on the belt. Additional friction between the drum 700 and the belt allows the belt to transfer motion or power more efficiently, particularly when under load, maintaining consistent movement and reducing the risk of failure.

In the non-limiting exemplary embodiment illustrated in FIG. 7B, bearings 712 may be pillow block bearings to reduce friction and wear, thereby improving longevity and decreasing maintenance requirements. Bearings 712 may be positioned to properly align the drums 700 to ensure smooth operation and prevent unnecessary stress on the conveyor 100. In an embodiment, automatic greasers can optionally be used to lubricate the rotation points of the drums 700, thereby decreasing the maintenance needed on the conveyor system 100. In some embodiments, the support blocks or bearings 712 may be mounted to a laterally adjustment mechanism. In such embodiments, the adjustment mechanism can be used to adjust either or both ends of the drum 700 to fine tune the alignment of the belt so that it stay centered on the drum 700.

Referring to FIG. 8, illustrated is a perspective view of one end 800 of a conveyor as disclosed herein, which includes a drive motor and gearbox assembly in accordance with an illustrative embodiment. As previously mentioned, conveyor 100 may include a drive motor and gearbox assembly 802 to turn the drive drum 110 and move the belt 112. In the non-limiting exemplary embodiment illustrated in FIG. 8, drive motor and gearbox assembly 802 may be operatively connected to drive drum 110 and extend from the exterior surface of the support frame 400 proximate to the drive drum 110. Drive motor and gearbox assembly 802 may be powered by any suitable power system. As a non-limiting example, power system may be a hydraulic power system configured to deliver fluid pressure to the drive motor. Hydraulic power is particularly well-suited for systems as disclosed herein as it offers reliable, adjustable power, which can be fine-tuned to the exact needs of the car wash conveyor system. Power system may be connected to the drive motor via the appropriate hoses and fittings, ensuring proper fluid flow and pressure to maintain smooth, consistent operation of the drive motor. In operation, a hydraulic power pack may supply pressurized hydraulic fluid to a hydraulic divider. Divider then evenly distributes the fluid to drive motor. The output of drive motor and gearbox assembly 802 can be finely adjusted to modify both the rate of movement of belt (not shown) and the weight capacity it can support. This control is crucial for effective cleaning, as it allows for consistent vehicle motion and speed throughout the washing process, a key advantage over traditional truck washes where speed can be inconsistent.

In an embodiment, power system may be a 7-horsepower hydraulic power pack, capable of delivering 8 gallons per minute at 1500 psi, a gearbox designed to handle 30,000 pounds of torque, a motor that delivers 8 gallons per minute, a torque coupling rated for 30,000 pounds, and a hose with a 3000-psi rating. In another embodiment, the power system may be a 20-horsepower hydraulic system configured to provide the necessary torque to move belt 112 smoothly and efficiently, even when under tremendous load from oversized vehicles. In another exemplary embodiment, the system may comprise a hydraulic power pack rated at 20 horsepower and capable of delivering 18 gallons per minute at 3500 psi. In another exemplary embodiment, the drive motor may be capable of handling 50,000 pounds of torque and delivering 16 gallons per minute. As an example, the torque coupling may be rated to handle 50,000 pounds and the hose may be rated for 6000 psi. In another embodiment, the conveyor 100 can also be driven via direct electric motor and gear reducer.

Referring to FIG. 9, illustrated is a perspective view of a portion 900 of a conveyor as disclosed herein having a belt in accordance with an illustrative embodiment. As previously mentioned, belt 112 may be disposed between the support rails 402 and around the drums 110, 114 and rollers 102. Belt 112 may include an inner surface 116 contacting the rollers 102 and an outer surface 118 configured to contact the tires of a vehicle. The inner surface 116 may be textured or formed from tacky material to create friction between belt 112 and the drums 110, 114, thereby preventing belt 112 from slipping under load and ensuring smooth, continuous movement of the conveyor 100. In some embodiments, outer surface 118 may also be textured or formed from tacky material to provide a non-slip grip between the outer surface 118 and the tired of a vehicle being moved by the conveyor 100.

In other embodiments, the inner surface 116 and outer surface 118 may feature different textures. As a non-limiting example, the outer surface 118 may feature a smooth or slick surface to minimize resistance as vehicles move along the conveyor 100, thereby minimizing undue stress or misalignment of belt 112. The smooth outer surface 118 may also prevent vehicles with misaligned frontends from pushing or otherwise moving belt 112 out of the proper position. That is, a smooth outer surface 118 may permit the tires of a vehicle with wheel misalignment to slightly slide to maintain at straight trajectory for the movement of the vehicle by the conveyor 100. With a smooth outer surface 118 and a textured inner surface 116, belt 112 provides both stability and traction necessary for car wash applications.

In some embodiments, belt 112 may be made of a lightweight, durable material. Non-limiting examples include polyurethane, natural rubber, synthetic rubber, steel, nylon, silica, polyester, carbon black, petroleum, and the like. In an embodiment, belt 112 may be constructed from a slightly elastic material to permit stretching during operation of the conveyor 100 and provide resilience to extreme temperatures. In some embodiments, belt 112 may be constructed from a composite material, such as metal fibers or belts surrounded by a rubber or rubber-like material to improve the strength. Each of these materials—such as rubber, PVC, nylon, vinyl, and other similar materials—has been chosen for their superior durability and resistance to wear and tear, attributes that are particularly advantageous in the abrasive environment of a car wash. These choices of material stand in contrast to traditional vehicle wash conveyors that often employ plastic belts/decks, known for their higher maintenance needs and greater likelihood of structural failure. Additionally, the material provides a high coefficient of friction, crucial for maintaining grip on vehicle tires and ensuring controlled movement through the car wash system. In some embodiments, the belt 112 can include fiber or steel wire reinforcement to enhance strength and durability. These fibers could include materials such as polyester, c, or other high-tensile synthetic fibers, which are embedded within the rubber, polyurethane, nylon, or PVC layers of the belt. Fiber reinforcement provides additional resistance to stretching, tearing, and other forms of mechanical stress, extending the operational lifespan of belt 112.

In some embodiments, belt 112 may have a thickness of ⅝ inches or ¾ inches. In some embodiments, belt 112 is wide enough, along is transverse width, to accommodate a wide range of vehicles, from compact cars to large tractor-trailers and other dual-wheel vehicles. In an exemplary embodiment, belt 112 is about 28 inches wide. In another exemplary embodiment, belt 112 is about 36 inches wide. In another exemplary embodiment, belt 112 is about 12-14 inches wide. In some embodiments, the belt 112 has a transverse width between about 12 inches and about 36 inches. These examples are merely illustrative, and the conveyor 100 as disclosed herein should not be limited to these specific dimensions or configurations.

In some embodiments, belt 112 is a continuous strip connected at its two ends to form a loop. The two ends of belt 112 may be connected by any appropriate means known in the art. Formed as a continuous loop, belt 112 is allowed to twist and bend dynamically, thereby improving the capacity of belt 112 to absorb and adapt to the lateral pressures exerted by vehicles leads to a reduction in belt failures. This multidirectional flexibility is essential for adapting to vehicles that do not follow a predictable linear path due to misalignment, as depicted by belt's 112 twisting capability. The integration of a continuous belt 112 incorporates a safety margin within the conveyor system 100, allowing for lateral movements without compromising the vehicle's position on the conveyor within the guide rails. This design consideration further minimizes the risk of operational disruptions and belt damage, leading to a decrease in downtime and extending the lifespan of the conveyor.

In some embodiments, belt 112 is comprised of a multi-ply construction, similar to tire ply technology, which contributes to its load-bearing capacity and robustness. In an exemplary embodiment, belt 112 is ½ inch in thickness and includes a 3-ply configuration. In another exemplary embodiment, belt 112 is ⅝ inch in thickness and includes a 4-ply configuration. In another exemplary embodiment, belt 112 is ¾ inch in thickness and includes a 5-ply configuration. However, the conveyor system 100 is not limited to the measurements described herein, and other thicknesses and plies may be utilized.

In the non-limiting exemplary embodiment illustrated in FIG. 9, belt 112 may be centered atop of the plurality of rollers 102. In some situations, belt 112 may shift horizontally in position across the conveyor 100 to compensate for the position of the vehicle's tires. For example, for vehicles with poor alignment, belt 112 may simply twist to accommodate the vehicle's alignment issue, and moves the vehicle along the length of conveyor 100. Belt 112 may then return to the center of the rollers 102 due to the combined effect of tension on belt 112 and the alignment (or shape) of drive drum 110 and idler drum 114. As the vehicle exits the conveyor 100, the tension in the belt 112, which is maintained by drive drum 110 and idler drum 114, naturally pulls belt 112 back to a neutral position, centered on the rollers 102.

Referring to FIG. 10, illustrated is a perspective view of a portion 1000 of a conveyor as disclosed herein and having a belt with vehicle movement stops in accordance with an illustrative embodiment. The outer surface 118 of the belt 112 may include vehicle movement stops 120 configured to help to push vehicles along the length of conveyor 100 as vehicle movement stops 120 move along the conveyor 100 with belt 112, ensuring that each vehicle remains properly aligned and progresses smoothly. In the non-limiting exemplary embodiment illustrated in FIG. 10, vehicle movement stops 120 may be pucks. Vehicle movement stops 120 may span the width of belt 112.

In the non-limiting exemplary embodiment illustrated in FIG. 10, multiple vehicle movement stops 120 may be linearly grouped to span the width of belt 112. In another embodiment, the length of each vehicle movement stop 120 is equal to the width of belt 112 such that only one vehicle movement stop 120 is needed to span the width of belt 112. Vehicle movement stops 120 may be positioned at a predetermining spacing along the length of belt 112 to accommodate vehicle tires. As a non-limiting example, vehicle movement stops 120 may be positioned at every three feet along the length of the belt 112. In another embodiment, vehicle movement stops 120002 may be placed at intervals of every 18 inches along the length of belt 112. In other embodiments, vehicle movement stops 120 may be spaced a further or lessor distance apart depending on the needs of the conveyor system 100. In an embodiment, vehicle movement stops 120 may be removably coupled to belt 112.

Vehicle movement stops 120 may be constructed from may be made from durable materials such as high-density polyethylene (HDPE), polyurethane, nylon, ultra-high-molecular-weight (UHMW) polyethylene, rubber, or Teflon (PTFE) or metals such as stainless steel, aluminum, or brass. These materials are selected for their ability to withstand the abrasive conditions of a car wash environment, including exposure to water, chemical, and mechanical wear. In some embodiments, these vehicle movement stops 120 can be molded into the belt, welded thereto, or bolted thereto.

Vehicle movement stops 120 may comprise various shapes. For example, vehicle movement stops 120 may be cylindrical, cubic, triangular, rectilinear, or custom design profiles that optimize their function in guiding and pushing vehicles through the wash. In some embodiments, each vehicle movement stop 120 has dimensions of 1.5 inches in height and 6 inches in width, though the dimensions can be adjusted depending on the specific requirements of the wash system. In some embodiments, the pattern alternates between rows of square vehicle movement stops 120 and rows of vehicle movement stops 120.

Vehicle movement stops 120 may be affixed to the belt 112 using methods that ensure their secure attachment, even under heavy loads and continuous operation. In some embodiments, vehicle movement stops 120 are mechanically fastened to the belt 112 using bolts or rivets that pass through pre-drilled holes in the belt 112. In other embodiments, vehicle movement stops 120 may be bonded to the belt 112 using adhesives that are resistant to water and chemicals. In another embodiment, vehicle movement stops 120 may be molded directly onto the belt 112 during the manufacturing process.

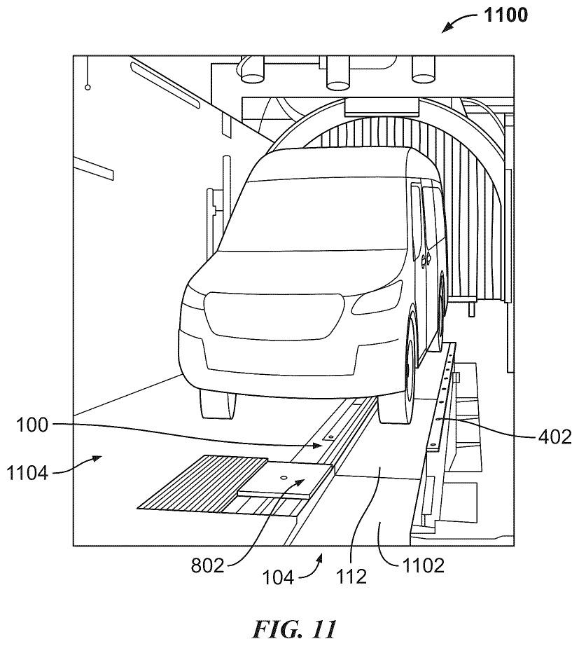

Referring to FIG. 11, illustrated is a front perspective view 1100 of a vehicle being moved by a conveyor 100 in accordance with an illustrative embodiment. In some embodiments, the first end 104 of conveyor 100 comprises a drive motor and gearbox assembly 802. As previously described, vehicle tires may be positioned on the belt 112. As the drive motor and gearbox assembly 802 rotates the drive drum (not shown), the drive drum imparts motion to the belt 112 and the belt 112 imparts motion to a vehicle positioned on the belt 112, thereby moving the vehicle along the length of the conveyor 100. Additionally, as previously described, rollers (not shown) may rotate when supporting the weight of the vehicle, thereby aiding in moving the vehicle along the length of the conveyor 100.

In the non-limiting exemplary embodiment illustrated in FIG. 11, conveyor 100 may also include a safety plate 1102 positioned at the first end 104. Safety plate 1102 may be configured to prevent unintentional contact with the belt return area. Safety plate 1102 effectively eliminates the possibility something getting caught in the belt return space by guiding obstructing objects away from the conveyor 100. In some embodiments, safety plate 1102 is a steel plate. In some embodiments, safety plate 1102 comprises a plurality of apertures (not shown) allowing for safety plate 1102 to be bolted to the ground near the first end 104 of the conveyor 100. As previously mentioned, support rails 402 may serve as guard rails configured to keep the tires of the vehicle on the conveyor 100.

As previously mentioned, conveyor 100 may form part of a comprehensive vehicle wash system. Many vehicles display alignment issues, causing tires not positioned on the conveyor 100 to improperly grip the ground and steer the vehicle. Misalignment can cause the vehicle to ride off the conveyor 100. Additionally, drivers may turn the wheel of the vehicle while the vehicle is traveling on the conveyor 100, causing the vehicle to ride off the conveyor 100. To address these concerns, a comprehensive wash system incorporating conveyor 100 may include a static guideway 1104 positioned opposite and parallel to the conveyor 100. Static guideway 1104 may be configured to reduce the grip of the tires on the ground, such as by providing an epoxy or other slick material on it, thereby preventing the misalignment of a vehicle's tires from causing the vehicle to ride off the conveyor 100. Additionally, if a driver were to turn the vehicle's wheel, the passenger (right) tires would slide across the epoxied floor in the same direction as the conveyor 100 instead of riding off the conveyor 100. In the non-limiting exemplary embodiment illustrated in FIG. 11, the driver (left) side tires of the vehicle may be positioned on the belt 112 of conveyor 100 and the passenger (right) side tires of the vehicle may be positioned on a static guideway 1104. The vehicle's transmission may be placed into neutral such that the passenger (right) side tires may freely roll on the static guideway 1104 while belt 112 pushes the driver (left) side tires forward without rotating.

Static guideway 1104 may be sized to accommodate the tires of an oversized vehicle such as commercial vans and heavy-duty trucks. As a non-limiting example, static guideway 1104 may be ½-inch-thick×30 inches wide. As previously mentioned, static guideway 1104 provides a smooth surface for tires to rotate as the vehicle traverses the length of conveyor 100. Static guideway 1104 may be comprised of various materials, including but not limited to polyethylene, nylon, or stainless steel. In some embodiments, the static guideway 1104 is smoothed to reduce surface irregularities. In some embodiments, an epoxy is applied to the static giveaway 1104 to improve smoothness. In some embodiments, the static guideway 1104 is lower than the conveyor 100 to simulate the crown of a road because the vehicle alignment may be configured to perform best with a crown on the driving surface. For example, the elevation difference between the conveyor 100 and the static guideway 1104 may be characterized by a ratio of about 1 inch of rise over about 60 inches of horizontal distance.

In another embodiment, driver (left) side and passenger (right) side tires may each be supported by separate distinct conveyors 100, each dedicated to a set of tires on either side of the vehicle. This multi-conveyor configuration ensures that both sides of a vehicle, both passenger and driver sides, are supported by their own conveyor 100, thereby improving balance and stability during transit. In a multi-conveyor system, where conveyors 100 are situated on both the driver and passenger sides, there may be a transverse slope between the conveyors 100 such that one conveyor 100 is positioned slightly lower than the other conveyor 100, creating a non-level configuration between the two side-by-side conveyors 100. This arrangement may enhance vehicle alignment and water drainage. In a multi-conveyor configuration, conveyors 100 may be synchronized by the power pack and divider to ensure that each conveyor 100 operates at the same speed, allowing for consistent vehicle motion and speed as the vehicle traverses the length of the conveyors 100.

In some embodiments, the conveyor 100 may include a gradient elevation from the second end 106 to the first end 104. More specifically, conveyor 100 may include a vertical rise along its length. For example, conveyor 100 may rise at a ratio of 1 inch over a span of 10 feet. The elevation gradient allows for vehicles to be positioned at closer intervals along conveyor 100 without risk of collision or impedance, effectively increasing the throughput and operational efficiency by enabling a higher volume of vehicles to be washed per hour. More specifically, the elevation gradient causes a vehicle to encounter a force due to gravity that naturally resists forward movement as the vehicle ascends the gradient. This gravitational resistance ensures that, in the absence of additional propulsion, the vehicle maintains its position or experiences a slight backward shift rather than advancing and potentially colliding with the preceding vehicle. Thus, as each vehicle traverses the elevation gradient, a natural separation is established between it and the subsequent vehicle entering the conveyor 100. This configuration helps to maintain a safe distance between vehicles, reducing the risk of collision and optimizing the spatial utilization of conveyor 100.

In embodiments where conveyor 100 includes an upward gradient along its length, the upward gradient may cause conveyor 100 to gradually rise from the second end 106 to the first end 104 of the conveyor 100. Accordingly, some rollers 102 may be raised relative to idler drum 116 to conform to the gradient. In this configuration, rollers 102 are positioned in a non-horizontal plane, aligned with the inclined plane of conveyor 100. As a result, the elevation of drive drum 110 and idler drum 114 is defined relative to the reference frame of the plane formed by rollers 102. This means that, even as belt 112 ascends along the gradient, drive drum 110 and idler drum 114 may remain slightly elevated relative to the plane formed by rollers 102. This elevation further ensures that rollers 102 engage and rotate only upon receiving a threshold level of downward force and weight, typically exerted by a vehicle positioned on belt 112. Belt 112, therefore, only comes into contact with rollers 102 positioned directly under the vehicle's tires, minimizing unnecessary roller 102 rotations. This feature reduces wear and tear on rollers 102, support blocks 108, and belt 112.

In some embodiments, conveyor 100 comprises a slight transverse inclination, or “camber,” across its width. For example, in the non-limiting exemplary embodiment illustrated in FIG. 11 wherein the conveyor 100 is positioned to support the drive (left) side tires of the vehicle, conveyor 100 may include a transverse camber sloping upward from the right side of the conveyor 100 to the left side of the conveyor 100. In some embodiments, the degree of inclination of the camber is characterized by a 1 inch rise over a span of 60 inches. This design is akin to the “positive camber” utilized in well-engineered roads, where the difference in height between the right and left sides of the vehicle slopes upward by 1 inch across a horizontal distance of 60 inches, emulating the mild, outward slope of roads that aids in water runoff and enhances vehicle stability. The transverse camber ensures that the conveyor 100 replicates the slope typically found in standard roads and aids in improving vehicle stability by optimizing the wheel alignment to the camber of the belt 112. Vehicles are often designed with variable wheel camber settings to cater to different operational conditions. These settings influence tire wear, grip, and stability. By incorporating a transverse camber, the conveyor 100 can accommodate vehicles with diverse wheel alignment configurations, thus obviating the need for frequent manual adjustments or additional alignment mechanisms. In some embodiments, this transverse camber is also present at the ground adjacent to the first end 104 and second end 106 of conveyor 100. This transverse camber allows a vehicle coupled to a load, such as a trailer or another vehicle, to be transported by the conveyor 100 without risk of the misalignment between vehicles causing the pulled load to ride off the side of the conveyor 100. The degree of the transverse camber can range according to the specific requirements of the vehicle being accommodated. While a typical example may feature a 1-inch rise over a 60-inch span, other embodiments of the system could potentially exhibit a gradient anywhere from a minimal tilt, such as 1-inch rise over 240-inch span, to a more pronounced incline, such as 12-inch rise over a 60-inch span.

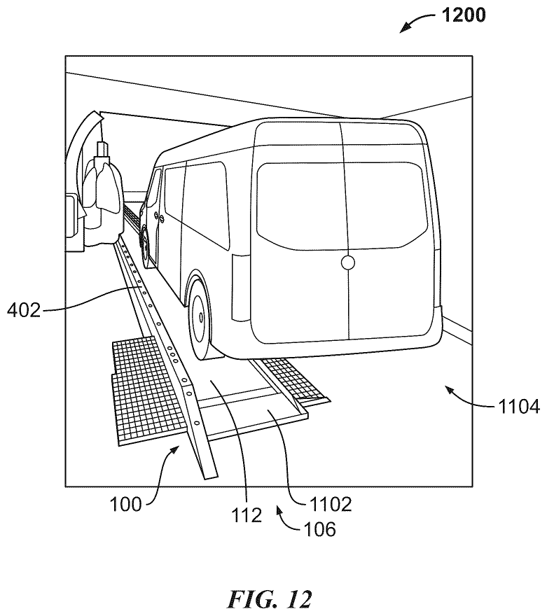

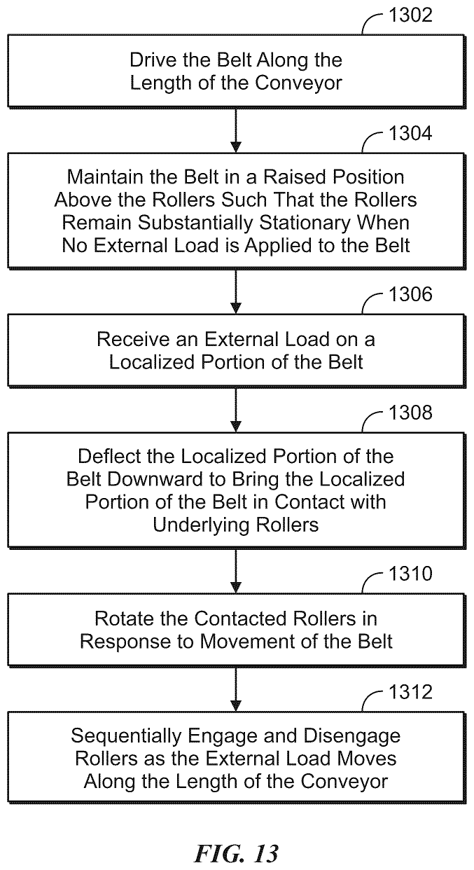

Referring to FIG. 12, illustrated is a rear perspective view 1200 of a vehicle being moved by a conveyor 100 in accordance with an illustrative embodiment. In the non-limiting exemplary embodiment illustrated in FIG. 12, a safety plate 1102 may also be positioned at the second end 106 of conveyor 100 to prevent foreign objects from obstructing rotation of the drive drum, as well as to protect persons around the end of the conveyor 100. As previously discussed, the support rails 402 may serve as guard rails to prevent vehicles from running off the conveyor 100 during movement. Additionally, as previously discussed, the comprehensive wash system may also include a static guideway 1104 configured to reduce friction between the ground and vehicle tires not contacting the conveyor 100.

Referring to FIG. 13, illustrated is a flowchart of a process of moving an oversized vehicle using a conveyor system in accordance with the disclosed principles. Flowchart 1300 may be implemented in a conveyor system such as conveyor 100 described herein. It shall be appreciated that a number of variations and modifications to the process illustrated in flowchart are contemplated, including, for example, the omission of one or more aspects of the process, the addition of further conditionals and operations, or the reorganization or separation of operations and conditionals into separate processes.

Flowchart begins with Step 1302, wherein the belt may be driven along the length of the conveyor. As previously discussed, the belt may be disposed around the drive drum, idler drum, and rollers such that the belt sits atop the plurality of rollers. The drive drum may be operationally coupled to a drive motor and gearbox assembly. As the drive motor and gearbox assembly rotates the drive drum, the drive drum may impart motion to the belt.

In Step 1304, the belt may be maintained in a raised position above the rollers such that the rollers remain substantially stationary when no external load is applied to the belt. For example, drive drum and/or idler drum may be sized such that the belt is suspended above the plurality of rollers and does not contact the rollers unless a sufficient downward force is applied to the belt. That is, the highest point of drive drum and idler drum may be elevated relative to the highest point of any of rollers. When there is no weight directly above a roller, belt may slide over the surface of the roller without contacting the roller or causing the roller to rotate.

In Step 1306, a localized portion of the belt may receive an external load. As a non-limiting example, a vehicle tire may provide an external load on a localized portion of the belt. In Step 1308, the localized portion of the belt may be deflected downward to bring the localized portion of the belt in contact with underlying rollers.

In Step 1310, the contacted rollers may be rotated in response to movement of the belt and the downward force of the vehicle's tire. That is, movement of the belt by the drive motor and gearbox assembly may cause the ends of the rollers may be rotated within the cylindrical apertures formed in support blocks. In an embodiment, the contacted rollers may not complete a full rotation even when sufficient weight is applied to turn the roller. For example, each roller may only rotate ½ to ¾ of a turn, which can be varied based on the diameter of the rollers, as the vehicle is moved along the conveyor.

In Step 1312, rollers may be sequentially engaged and disengaged as the external load moves along the length of the conveyor. The external load moves with the belt as the belt moves along the length of the conveyor. A given roller is engaged by the belt such that substantial rotation of the roller occurs only when the external load is positioned above the roller. A given roller is disengaged from the belt such that substantial rotation of the roller does not occur when the external load is removed. This process may be repeated to convey an oversized vehicle from a second end of a conveyor to a first end of a conveyor.

Although the conveyor 100 has been described primarily in the context of vehicle wash systems for transporting cars and trucks, it is not limited to these applications. The conveyor system 100 disclosed herein is adaptable for transporting a wide variety of vehicles and loads, including but not limited to cars, trucks, trailers, buses, boats, airplanes, motorcycles, bicycles, all-terrain vehicles (ATVs), recreational vehicles (RVs), and other wheeled or non-wheeled vehicles. Additionally, the conveyor system 100 can accommodate vehicles and loads that are being pulled or towed, such as trailers, caravans, and other towable equipment. Furthermore, the conveyor system 100 can be employed to transport non-vehicle loads, including but not limited to cargo containers, industrial equipment, pallets, heavy machinery, agricultural equipment, construction materials, packaged goods, and any other type of load that requires controlled movement along a length of the conveyor 100.

While this disclosure has been particularly shown and described with reference to preferred embodiments, it will be understood by those skilled in the pertinent field of art that various changes in form and detail may be made therein without departing from the spirit and scope of the disclosed principles. The inventors expect skilled artisans to employ such variations as appropriate, and the inventors intend the disclosed principles to be practiced otherwise than as specifically described herein. Accordingly, this disclosure includes all modifications and equivalents of the subject matter recited in the claims appended hereto, as permitted by applicable law. Moreover, any combination of the above-described elements in all possible variations thereof is encompassed by the disclosure unless otherwise indicated herein or otherwise clearly contradicted by context.

Also, while various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the disclosed principles set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” or disclosed principles in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

Moreover, the Abstract is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the claims reflect, inventive subject matter lies in less than all features of a single disclosed embodiment. Thus, the following claims are hereby incorporated into the Detailed Description, with each claim standing on its own as a separate embodiment.

Any and all publications, patents, and patent applications cited in this disclosure are herein incorporated by reference as if each were specifically and individually indicated to be incorporated by reference and set forth in its entirety herein.

What is claimed is:

1. A conveyor system for oversized vehicles, the conveyor system comprising:
a support frame extending the length of the conveyor;
a plurality of cylindrical rollers positioned at intervals along the length of the conveyor;
a plurality of support blocks connected to the support frame, each support block comprising at least one aperture configured to rotatably receive an end of a cylindrical roller;
a drive drum connected to the support frame at a first end of the conveyor, the drive drum being connected to a drive motor and gearbox assembly configured to rotate the drive drum;
an idler drum connected to the frame at a second end of the conveyor opposite the drive drum; and
a belt in contact with the drive drum and the idler drum, wherein the belt rotates over the drive drum and the idler drum as it is driven by the drive motor, and wherein each roller only rotates in response to a vehicle load pressing the belt against the roller.

2. The conveyor system of claim 1, wherein the support frame comprises parallel support rails extending the length of the conveyor and wherein support rails are connected via cross members.

3. The conveyor system of claim 1, wherein each roller is comprised of stainless steel.

4. The conveyor system of claim 1, wherein each roller comprises an outer shell with a central opening and an inner rod fit through the central opening, wherein the central rod extends beyond the outer shell and forms an axle about which the roller rotates.

5. The conveyor system of claim 1, wherein the support blocks are comprised of self-lubricating material.

6. The conveyor of claim 5, wherein the support blocks are comprised of ultra-high-molecular-weight polyethylene (UHMW).

7. The conveyor of claim 1, wherein the support blocks are removably coupled to the support frame via fasteners, and wherein the ends of the rollers are slip-fit into the apertures formed in the support blocks.

8. The conveyor system of claim 1, wherein the drive drum has a crowned shape, with a larger diameter at its longitudinal center point relative to its cylindrical ends.

9. The conveyor system of claim 1, wherein the drive motor is powered by a hydraulic power pack.

10. The conveyor system of claim 1, wherein the belt is comprised of rubber.

11. The conveyor system of claim 1, wherein the belt further comprises vehicle movement stops on an exterior surface thereof and configured to contact vehicle tires to push the vehicles along the length of the conveyor as the belt moves.

12. The conveyor system of claim 1, further comprising a static guideway opposite and parallel to the conveyor configured to reduce the grip of tires on the ground.

13. The conveyor system of claim 1, wherein the support blocks comprise a separable upper portion and lower portion, wherein each portion defines a portion of the apertures.

14. The conveyor system of claim 1, further comprising debris sleeves mounted on the ends of the rollers and configured to prevent water and debris from entering the apertures formed in support blocks.

15. The conveyor system of claim 1, wherein the conveyor includes a gradient elevation from the second end to the first end and a transverse inclination across the width of the conveyor.

16. The conveyor system of claim 1, further comprising safety plates positioned at the first end and second end of the conveyor.

17. A method of conveying an oversized vehicle utilizing a conveyor system comprising:
a support frame extending the length of the conveyor;
a plurality of cylindrical rollers positioned at intervals along the length of the conveyor;
a plurality of support blocks connected to the support frame, each support block comprising at least one aperture configured to rotatably receive an end of a cylindrical roller;
a drive drum connected to the support frame at a first end of the conveyor, the drive drum being connected to a drive motor and gearbox assembly configured to rotate the drive drum;
an idler drum connected to the frame at a second end of the conveyor opposite the drive drum; and
a belt in contact with the drive drum and the idler drum, wherein the belt rotates over the drive drum and the idler drum as it is driven by the drive motor, and wherein each roller only rotates in response to a tire of a vehicle load pressing the belt against the roller, the method comprising the steps of:
driving the belt along the length of the conveyor;
maintaining the belt in a raised position above the rollers such that the rollers remain substantially stationary when no vehicle tire load is applied to the belt;
receiving a load from a vehicle tire on a localized portion of the belt;
deflecting the localized portion of the belt downward to bring the localized portion of the belt in contact with underlying rollers;
rotating the contacted rollers in response to movement of the belt; and
sequentially engaging and disengaging rollers as the vehicle load moves along the length of the conveyor.

18. The method of claim 17, wherein maintaining the belt in the raised position comprises tensioning the belt between the drive drum and idler drum.

19. The method of claim 17, wherein the belt is comprised of rubber and the rollers are comprised of stainless steel.

20. The method of claim 17, wherein the belt of the conveyor system further comprises vehicle movement stops configured to contact tires of vehicle to push the vehicles along the length of the conveyor as the belt moves.
